(19) United States
(12) Patent Application Publication
(10) Pub. No.: US 2023/0162296 A1
(43) Pub. Date: May 25, 2023

(54) METHOD FOR EVALUATING AGRICULTURAL DROUGHT BASED ON IMPROVED CROP MOISTURE INDEX (CMI)

(71) Applicant: Changjiang River Scientific Research Institute of Changjiang Water Resources Commission, Wuhan (CN)

(72) Inventors: Jijun XU, Wuhan (CN); Mingzhi YANG, Wuhan (CN); Zhe YUAN, Wuhan (CN); Junjun HUO, Wuhan (CN); Dong WANG, Wuhan (CN); Weishuai CHENG, Wuhan (CN); Sinuo LI, Wuhan (CN); Jinhui DAI, Wuhan (CN)

(21) Appl. No.: 17/992,996

(22) Filed: Nov. 23, 2022

(30) Foreign Application Priority Data
Nov. 23, 2021 (CN) 202111393790.0

(51) Int. Cl. G06Q 50/02; G06Q 10/0639

(52) U.S. Cl. CPC G06Q 50/02; G06Q 10/06393

(57) ABSTRACT

A method is provided for evaluating agricultural drought based on an improved crop moisture index (CMI). The method includes the following steps: S1, constructing a basic information database; S2, improving a soil water balance equation; S3, performing irrigation design; S4, constructing a CMI-based drought evaluation model; and S5, estimating a CMI by adopting the constructed CMI-based drought evaluation model, and evaluating historical and current drought severity of a region in accordance with a CMI-based drought grading standard. According to the method, weather information and agricultural irrigation activities are integrated to dynamically evaluate drought development, the accuracy of agricultural drought evaluation and the timeliness of monitoring are improved, and the method has advantages in drought evaluation of a high-frequency irrigation farming area, so that a new method is provided for in-depth knowledge of an agricultural drought mechanism under the influence of strong human activities.

### CROSS REFERENCE TO RELATED APPLICATION

This patent application claims the benefit and priority of Chinese Patent Application No. 202111393790.0, filed with the China National Intellectual Property Administration on Nov. 23, 2021, the disclosure of which is incorporated by reference herein in its entirety as part of the present application.

### TECHNICAL FIELD

The present disclosure relates to the technical field of monitoring and early monitoring for agricultural drought, and in particular to a method for evaluating agricultural drought based on an improved crop moisture index (CMI).

### BACKGROUND

Drought is one of the most common disasters. Under the influence of climate change and other factors, the past decade have witnessed significantly growing tendency in the frequency and severity of drought, which has been closely watched by experts in related fields at home and abroad. Drought is traditionally defined as a natural phenomenon resulting from a persistent water shortage in a particular system due to changes in meteorological conditions. In fact, any system with an amount of water below a normal level will be considered in a state of drought, regardless of whether the water shortage is due to meteorological or human factors. In areas under strong intervention of human activities, drought is no longer a pure natural phenomenon, but a compound effect driven by both natural and human factors. Human exploitation and utilization of water resources has significantly affected the evolution direction of hydrological cycle, changed the storage state and hydraulic relationship of river, soil and underground aquifer, and caused the change of regulation and storage function of river, soil and groundwater system, which exerts a profound impact on the formation and development process of drought. This feedback to natural systems has been changing the timing, development and severity of drought.

The impact of human activities on drought has become an issue of common concern for global drought researchers. Considering the complex interaction between natural and social water cycle, human factors are included into the definition and analysis methods of drought, revealing that the impact of human activities on the formation and development of drought is an important development direction of drought research. Anne F. Van Loon et al. (2018) argued that in this human-influenced era, drought disaster is no longer a natural disaster in the strict sense, but has become a product of natural and human factors, and on this basis, put forward the concept of drought in the Anthropocene:

(a) Drought refers to abnormal water scarcity in a particular system due to the interaction between natural climate and human activity in a modern era where high-intensity human activity has an omni-directional and profound impact on the Earth system (Anthropocene);

(b) Drought is driven by climatic and human factors;

(c) Human intervention may change the severity of drought;

(d) The impact of drought depends on the severity of the drought and the vulnerability of the human system; and

(e) Long-term human feedback on drought changes the threshold for assessing the occurrence of drought (the normal water condition of a particular system in a region), which determines the timing and severity of drought.

As a type of drought, agricultural drought is closely related to meteorological conditions, soil moisture, irrigation activities, crop growth stage and other factors, and mechanisms for the generation and development of agricultural drought may also be affected by natural factors and human factors. Among the foregoing factors, irrigation plays a vital role in agricultural production activities, which can ensure soil moisture and increase crop yield per unit area. At present, irrigated land accounts for only 20% of the globe's total arable land, whereas its crop output represents up to 40% of the global grain production. In China, irrigation has become a routine agricultural management practice to ensure grain production. In accordance with the irrigation project, quantitative irrigation is carried out in a specific period (the critical growth period of crops). This system of agricultural management featuring specified time and amount of irrigation allows to control soil moisture of farmland in a critical crop growing period within a reasonable limit. As with climate change, the long-term feedback of irrigation on soil moisture circulation changes the threshold for the occurrence of agricultural droughts, thus greatly affecting the mechanisms for the generation and development of droughts. Agricultural irrigation activities increase soil moisture supply (which can be considered as an increase in precipitation) in certain months (crop production period), altering the temporal and spatial distribution of soil moisture in farmland and thus affecting the frequency and intensity of agricultural droughts, such as delaying drought occurrences, weakening drought, ending a drought ahead of time, etc. This is an adaptation mechanism for human against local climatic conditions and their changes.

As a result of irrigation interventions, soil moisture content in farmland remains within a soil moisture range suitable for crop growth. However, some traditional drought evaluation methods based on water balance may misjudge the actual severity of drought, leading to inconsistency in monitoring results with the actual situation. Therefore, there is an urgent need for a drought evaluation index that can combine natural and human factors to identify actual drought severity in an agricultural irrigated area and to distinguish the actual severity.

Crop moisture index (CMI) is an agricultural drought index based on weekly average temperature and precipitation put forward by W. C. Palmer on the basis of Palmer Drought Severity Index (PDSI) in 1968. Based on the concept of “Climatically Appropriate for Existing Condition Precipitation” (CAFEC) put forward in the early days, the CMI leads to the concept of “Climatically Appropriate for Existing Condition Evapotranspiration”. The difference between an expected value and an actual evapotranspiration (abnormal deficit of evapotranspiration) is used to reflect the current soil moisture condition, which allows to develop a systematic method to analyze the severity of agricultural drought and determine the duration of drought. Compared with other drought indexes, CMI is more rigorous and systematic, comprehensively considering factors such as evapotranspiration, runoff and soil water exchange, as well as the influence of early soil moisture on drought. In the meanwhile, the drought index is derived by using the principle of water balance, which conveys a clear and distinct physical meaning, can reasonably describe the characteristics of drought, and has a better time-space comparison. So far, CMI is still used by United States Department of Agriculture (USDA) and published in Weekly Weather and Crop Bulletin (WWCB) as an indicator of short-term crop water demand.

From the perspective of the causes of drought, although precipitation, temperature and other meteorological factors are the leading causes of agricultural drought, agricultural irrigation is also a very important factor affecting the change of agricultural drought. Irrigation water or rainwater cannot be directly absorbed by crops and thus needs to be first converted into soil water. Crops then absorb the soil water through roots to obtain the water needed for their growth and development. This process may greatly affect the dynamics and transformation of soil moisture. However, the traditional CMI cannot reflect this process well.

### SUMMARY

In view of the above-mentioned problems in the prior art, the present disclosure provides a method for evaluating agricultural drought based on an improved crop moisture index (CMI). According to the method, based on the definition of drought in the Anthropocene and the construction principle of CMI, and in combination with the characteristics of agricultural drought and the basic characteristics of irrigated agriculture, a water balance model in an original mode is modified, and irrigation terms are introduced into the process of calculating soil moisture, so as to improve the sensitivity to the dynamic change in dry and wet conditions of farmland soil, and improve the accuracy of agricultural drought evaluation and the timeliness of agricultural drought monitoring. The method makes the monitoring results of the whole drought change consistent with the actual situation, and is of practical significance to the evaluation and monitoring of agricultural drought.

The present disclosure is implemented by the following technical solutions:

The present disclosure provides a method for evaluating agricultural drought based on an improved crop moisture index (CMI), including:

step S1: constructing a basic information database, where the basic information database includes information on a meteorological station in a research area, meteorological observation data, information on soil characteristics in a region where the meteorological station is located, information on crop characteristics, information on irrigation systems, and irrigation-related information;

step S2: improving a soil water balance equation, which specifically includes considering a crop coefficient during evapotranspiration calculation, and adding an irrigation parameter to a calculation formula for soil water loss and a calculation formula for evapotranspiration;

step S3: setting an irrigation start threshold, calculating weekly soil water deficit by using the improved soil water balance equation in step S2, and then allocating irrigation water use per unit area within a year according to the information on irrigation systems;

step S4: constructing a CMI-based drought evaluation model by calculating, in combination with calculation of soil water balance, an evapotranspiration anomaly index based on the constructed basic information database and the improved soil water balance equation, and then calculating an excess moisture index according to a relevant CMI calculation formula; and

step S5: estimating a CMI by adopting the constructed CMI-based drought evaluation model, and evaluating historical and current drought severity of a region in accordance with a CMI-based drought grading standard.

Further, said constructing a basic information database in step S1 includes:

collecting information on a meteorological station in a research area, such as latitude and longitude coordinates and a sea level elevation of the meteorological station;

collecting a series of meteorological observation data, such as precipitation, hours of sunshine, radiation, wind speed, relative humidity, mean temperature, maximum temperature and minimum temperature;

collecting information on soil characteristics in a region where the meteorological station is located, such as a soil thickness, particle size composition, a field capacity rate and a wilting coefficient;

collecting information on crop characteristics, such as main crop types, planting dates, harvest dates, start and end dates of each growth period and a crop coefficient for each growth period in the region where the meteorological station is located;

collecting information on irrigation systems, such as a crop irrigation norm, an irrigation time, an irrigation frequency, and a single irrigation amount; and

collecting irrigation-related information, such as an actual irrigation water use over the years, an actual irrigation area and an effective utilization coefficient of irrigation water for a specified region.

Further, said considering a crop coefficient during evapotranspiration calculation in step S2 specifically includes:

invoking the constructed basic information database to obtain a crop coefficient IC, and calculating a potential evapotranspiration value ET_{c} of field crops in each growth period to replace potential evapotranspiration (PE) in an original CMI, where the potential evapotranspiration value of crops is calculated according to the Penman-Monteith equation provided by the Food and Agriculture Organization of the United Nations (FAO-PM equation) as follows:

ET_{c}=K_{c}·PE (1)

where ET_{c} represents a potential evapotranspiration value of crops (in mm) during a calculation period; PE represents potential evapotranspiration, namely reference crop evapotranspiration (in mm) during the calculation period; and K_{c} represents a crop coefficient within the corresponding time period; and

said adding an irrigation parameter to a calculation formula for soil water loss and a calculation formula for evapotranspiration in step S2 specifically includes:

adding the irrigation parameter to the following formulas: the calculation formula for water loss of a surface soil layer (Ls), the calculation formula for water loss of an underlying soil layer (Lu) and the calculation formula for actual evapotranspiration (ET), where the revised calculation formulas are as follows:

L_{S}=min(ET_{c}−P−I,PSs) (2)

Lu=min[(ETc−P−I−Ls)·PSu/AWC,PSu] (3)

ET=Ls+Lu+P+I (4)

where P represents precipitation (in mm); I represents an irrigation amount (in mm); PSs and PSu represent an initial moisture content (in mm) of a surface soil layer and an initial moisture content (in mm) of an underlying soil layer, respectively; AWC represents an effective soil moisture content (in mm) which is obtained from a current soil moisture content minus a wilting moisture content; and R and RO represent a soil water supply (in mm) and runoff (in mm), respectively, R and RO being expressed as follows:

R=Su+Ss−PSs+PSu; if R>0,R+PSu+PSs≤AWC (5)

RO=PSu+PSs−Ss−Su−AWC; if RO>0 (6)

Ss=PSs−Ls (7)

Su=PSu−Lu (8)

where Ss and Su represent a moisture content of a surface soil layer and a moisture content of an underlying soil layer at the end of the period, respectively.

Further, step S3 includes:

invoking the constructed basic information database to obtain an actual irrigation water use over the years, an irrigation area and an effective utilization coefficient of irrigation water, and calculating irrigation water use per unit area;

setting the irrigation start threshold according to requirements of crop growth for soil moisture, where the irrigation start threshold is a ratio of a minimum soil moisture content to a field capacity required to ensure normal growth of crops, and is used to determine critical conditions for irrigation, irrigation is started only when the soil moisture content is below a threshold, and for a specified growth period, a single irrigation amount in a jth week is expressed as follows:

$${I}_{j} = \{ \begin{matrix}0 & if T \leq {SW}_{j} / FC \\ min ( {D}_{j} , Iq ) & if T > {SW}_{j} / FC\end{matrix} \qquad ( 9 )$$

$${\sum }_{j = 1}^{m} {I}_{j} = {W}_{irr} \qquad ( 10 )$$

where n represents a number of weeks of a specified growth period, and j represents a jth week of the crop growth period, and j=1, 2, . . . , n; Iⱼ represents a single irrigation amount (in mm) at the jth week; T represents an irrigation start threshold (in mm); SWⱼ represents an initial moisture content (in mm) at the jth week; FC represents a soil field capacity (in mm); I_{q} represents an irrigating water quota (in mm) within the crop growth period; m represents a total irrigation frequency within a year; Wᵢᵣᵣ represents an irrigation norm (in mm); and Dⱼ represents a soil moisture deficit (in mm) at the jth week, which is expressed as follows:

$${D}_{j} = \qquad ( 11 )$$

$$\{ \begin{matrix}0 & \\ & if AWC - {PSs}_{j} - {PSu}_{j} \leq {P}_{j} + {I}_{j} \\ & if AWC - {PSs}_{j} - {PSu}_{j} > {P}_{j} + {I}_{j} \\ AWC - {PSs}_{j} - {PSu}_{j} - {P}_{j} - {I}_{j} & \end{matrix}$$

allocating the irrigation water use per unit area to each crop growth period according to the irrigation start threshold, the soil moisture deficit, the irrigation time, the irrigating water quota for single irrigation and the irrigation frequency, which specifically includes:

first, according to information on irrigation systems in the basic information database, identifying whether a current calculation period is within an irrigation period: if not, performing no irrigation within this calculation period, returning to a calculation process of soil water balance, and continuing to calculate a soil hydrological process (SHP); if yes, proceeding into a process of identifying the irrigation start threshold;

according to the calculation results of soil water balance, calculating a ratio of a soil moisture content to a field capacity: if the ratio is above the irrigation start threshold, performing no irrigation within this calculation period, returning to the calculation process of soil water balance, and continuing to calculate the SHP; if the ratio is below the irrigation start threshold, proceeding into a process of identifying the irrigation frequency within the growth period;

if the current irrigation frequency is higher than the total irrigation frequency within this growth period, performing no irrigation during this calculation period, returning to the calculation process of soil water balance, and continuing to calculate the SHP; if the current irrigation frequency is not higher than the total irrigation frequency within this growth period, proceeding into a process of identifying the total crop irrigation frequency;

if the current irrigation frequency is higher than the total crop irrigation frequency, performing no irrigation during this calculation period, returning to the calculation process of soil water balance, and continuing to calculate the SHP; if the current irrigation frequency is not higher than the total crop irrigation frequency, starting irrigation, and then proceeding into a process of calculating an irrigation amount, where the irrigation amount during this calculation period is equal to the irrigation water use per unit area minus a cumulative irrigation amount of previous irrigation; and

according to the calculation results of water balance, calculating a soil moisture deficit D: if the soil moisture deficit is higher than the irrigating water quota Iq, starting irrigation, when the irrigation amount in this calculation period is equal to the crop irrigating water quota, returning to the calculation process of soil water balance, and continuing to calculate the SHP; if the soil moisture deficit is lower than the irrigating water quota, starting irrigation, when the irrigation amount in this calculation period is equal to the soil moisture deficit, returning to the calculation process of soil water balance, and continuing to calculate the SHP.

Further, the evapotranspiration anomaly index in step S4 is calculated according to the following formula:

$$a = \overline{ET} / \overline{{ET}_{c}} \qquad ( 12 )$$

$$CET = a \cdot {ET}_{c} \qquad ( 13 )$$

$$DE = ( DE - CET ) / {a}^{1 / 2} \qquad ( 14 )$$

$${FY}_{j} = \frac{2}{3} \cdot {FY}_{j - 1} + 1.8 \cdot DE \qquad ( 15 )$$

$${Y}_{j} = \{ \begin{matrix}{FY}_{j} & if {FY}_{j} \leq 0 \\ \frac{PSs + PSu + Ss + Su}{2} \cdot AWC \cdot {FY}_{j} & if {FY}_{j} > 0\end{matrix} \qquad ( 16 )$$

where α represents an evapotranspiration coefficient; E̅T̅ and E̅T̅_̅{̅c̅}̅ respectively represent a climatologically actual evapotranspiration and a climatologically potential evapotranspiration (in mm), which is obtained by calculating a long-time average annual value; CET represents an expected evapotranspiration; Y represents the evapotranspiration anomaly index; FY represents a first approximate value of Y; and DE represents an evapotranspiration anomaly value within a calculation stride;

the excess moisture index is calculated according to the following formula:

$${H}_{j} = \{ \begin{matrix}{G}_{j - 1} & if {G}_{j - 1} < 12.7 \\ 25.4 & if 12.7 \leq {G}_{j - 1} < 25.4 \\ \frac{{G}_{j - 1}}{2} & if {G}_{j - 1} > 25.4\end{matrix} \qquad ( 17 )$$

$${G}_{j} = {G}_{j - 1} - H + \frac{PSs + PSu + Ss + Su}{2} \cdot AWC \cdot R + RO \qquad ( 18 )$$

where G denotes the excess moisture index; and H denotes a regression factor;

the crop moisture index, as a sum of the evapotranspiration anomaly index and the excess moisture index, is expressed according to the following formula:

CMIⱼ=Yⱼ+Gⱼ (19)

where CMI represents the crop moisture index, and

the CMI-based drought evaluation model is constructed in combination with the formulas (1)-(19).

Further, step S5 specifically includes: according to the formulas (1)-(19), compiling a calculation program of the CMI-based drought evaluation model in Visual Studio, an application development environment for Windows platform, calculating the CMI of each meteorological station in the research area, and evaluating historical and current drought severity of the research area in accordance with a CMI-based drought grading standard.

Compared with the prior art, the present disclosure has the following beneficial effects:

By improving the soil water balance equation in the CMI model, the influence of irrigation activities is taken into consideration when calculating soil moisture, which makes it possible to more accurately reflect the actual changes of soil moisture, improve the sensitivity to short-term and dynamic changes of dry and wet conditions of farmland soil, and keep the whole process of monitoring the change of drought severity more consistent with the actual situation. In the meanwhile, the method can improve the accuracy of drought evaluation and prediction, overcomes the defect that an existing agricultural drought index evaluation model has a poor effect when applied to areas with strong human activities, makes it more suitable for irrigated farming areas, and has practical significance for practical applications such as agricultural drought evaluation, monitoring and early warning.

### BRIEF DESCRIPTION OF THE DRAWINGS

FIG. 1 is a flowchart of a method for evaluating agricultural drought based on an improved crop moisture index (CMI) according to an embodiment of the present disclosure;

FIG. 2 is a diagram showing an operation flow of an irrigation module and its relationship with a soil water balance module according to an embodiment of the present disclosure;

FIG. 3 is a diagram showing distribution of meteorological stations in the Haihe Basin according to an embodiment of the present disclosure;

FIG. 4 shows a comparison of simulated soil moisture results from April 2007 to October 2012 at Luancheng Station based on a soil water balance equation before improvement and a soil water balance equation after improvement;

FIG. 5 shows a comparison of two kinds of CMI with time series at Luancheng Station in 2002;

FIG. 6 shows spatial distribution of drought in the Haihe Basin in summer and autumn of 2002 based on the improved CMI according to an embodiment of the present disclosure; and

FIG. 7 shows spatial distribution of drought in the Haihe Basin in summer and autumn of 2002 based on the CMI in the prior art.

### DETAILED DESCRIPTION OF THE EMBODIMENTS

To make the technical solutions and advantages of the embodiments of the present disclosure clearer, the technical solutions in examples of the present disclosure are clearly and completely described below with reference to the accompanying drawings in embodiments of the present disclosure.

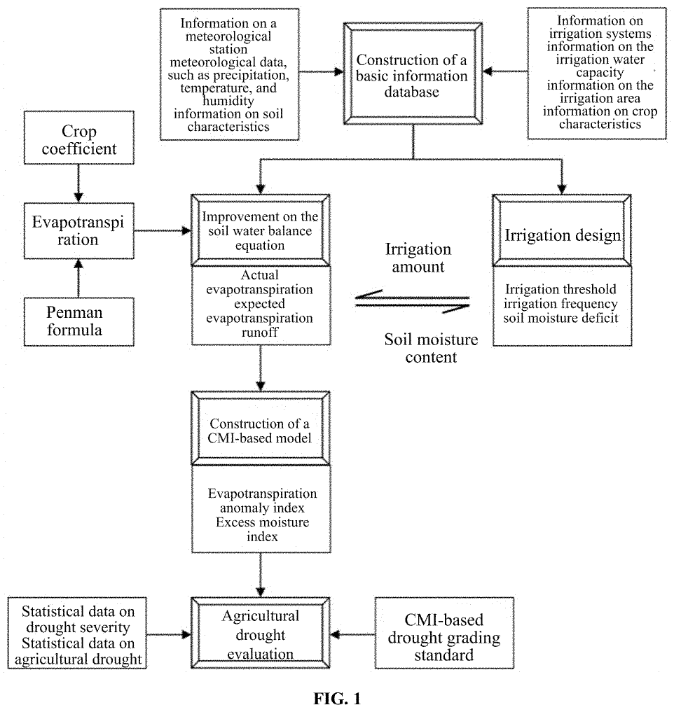

As shown in FIG. 1, an embodiment of the present disclosure provides a method for evaluating agricultural drought based on an improved crop moisture index (CMI).

The method includes the following steps.

Step S1: construct a basic information database. The basic information database includes a diagram showing distribution of meteorological stations, meteorological observation data, information on soil characteristics in a region where the meteorological station is located, information on crop parameters, information on irrigation systems, and irrigation-related information, where the irrigation-related information includes actual irrigation water use over the years, an actual irrigation area and an effective utilization coefficient of irrigation water for a specified region.

The basic information database is constructed according to the following process:

(1) Collect information on a meteorological station in a research area, such as latitude and longitude coordinates and a sea level elevation of the meteorological station;

(2) Collect a series of meteorological observation data, such as precipitation, hours of sunshine, radiation, wind speed, relative humidity, mean temperature, maximum temperature and minimum temperature;

(3) Collect information on soil characteristics in a region where the meteorological station is located, such as a soil thickness, particle size composition, a field capacity rate and a wilting coefficient;

(4) Collect information on crop characteristics, such as main crop types, planting dates, harvest dates, start and end dates of each growth period and a crop coefficient for each growth period in the region where the meteorological station is located;

(5) Collect information on irrigation systems, such as a crop irrigation norm, an irrigation time, an irrigation frequency, and a single irrigation amount; and

(6) Collect irrigation-related information, such as an actual irrigation water use over the years, an actual irrigation area and an effective utilization coefficient of irrigation water for a specified region. Step S2: improve a soil water balance equation. The soil water balance equation is improved from two aspects: 1, considering a crop coefficient during evapotranspiration calculation, and 2, adding an irrigation parameter.

Step S2 specifically includes:

(1) Consider a Crop Coefficient During Evapotranspiration Calculation

Invoke the constructed basic information database to obtain a crop coefficient K_{c}, and calculate a potential evapotranspiration value ET_{c} of field crops in each growth period to replace potential evapotranspiration (PE) in an original CMI. Besides, the potential evapotranspiration value of crops is calculated according to the Penman-Monteith equation provided by the Food and Agriculture Organization of the United Nations (FAO-PM equation), and the Thornthwaite's approach is no longer used. Calculation formulas are as follows.

ET_{c}=K_{c}·PE (1)

Where ET_{c} represents a potential evapotranspiration value of crops (in mm) during a calculation period; PE represents potential evapotranspiration, namely reference crop evapotranspiration (in mm) during the calculation period; and K_{c} represents a crop coefficient within the corresponding time period.

(2) Add an Irrigation Parameter to a Formula for Soil Water Loss and a Formula for Evapotranspiration

Modification needs to be made on the following calculation formulas: the calculation formula for water loss of a surface soil layer (Ls) calculation formula for water loss of an underlying soil layer (Lu) and the calculation formula for actual evapotranspiration (ET). The revised calculation formulas are as follows:

L_{S}=min(ET_{c}−P−I,PSs) (2)

Lu=min[(ETc−P−I−Ls)·PSu/AWC,PSu] (3)

ET=Ls+Lu+P+I (4)

Where P represents precipitation (in mm); I represents an irrigation amount ( ); PSs and PSu represent an initial moisture content (in mm) of a surface soil layer and an initial moisture content (in mm) of an underlying soil layer, respectively; AWC represents an effective soil moisture content (in mm) which is obtained from a current soil moisture content minus a wilting moisture content; and R and RO represent a soil water supply (in mm) and runoff (in mm), respectively, R and RO being expressed as follows:

R=Su+Ss−PSs+PSu; if R>0,R+PSu+PSs≤AWC (5)

RO=PSu+PSs−Ss−Su−AWC; if RO>0 (6)

Ss=PSs−Ls (7)

Su=PSu−Lu (8)

Where Ss and Su represent a moisture content of a surface soil layer and a moisture content of an underlying soil layer at the end of the period, respectively (in mm).

Compile, according to the formulas (1)-(8), a calculation program in Visual Studio 2012, an application development environment for Windows platform in Fortran, and design a soil water balance module.

Step S3: perform irrigation design. Set an irrigation start threshold, calculate weekly soil water deficit by using the improved soil water balance equation in step S2, and then allocate irrigation water use per unit area within a year according to the information on irrigation systems such as a crop irrigation norm and a single irrigation amount.

Step S3 specifically includes the following process.

(1) Determine Irrigation Water Use Per Unit Area:

Invoke the constructed basic information database to obtain data such as an actual irrigation water use over the years, an irrigation area and an effective utilization coefficient of irrigation water, and calculate irrigation water use per unit area;

(2) Set an Irrigation Start Threshold:

Set the irrigation start threshold according to requirements of crop growth for soil moisture, where the irrigation start threshold is a ratio of a minimum soil moisture content to a field capacity required to ensure normal growth of crops, and is used to determine critical conditions for irrigation, irrigation is started only when the soil moisture content is below a threshold, and for a specified growth period (covering a total of n weeks), a single irrigation amount in a jth week (j=1, 2, . . . , n) is expressed as follows:

$${I}_{f} = \{ \begin{matrix}0 & \\ & if T \leq {SW}_{f} / FC \\ & if T > {SW}_{f} / FC \\ min ( {D}_{f} , Iq ) & \end{matrix} \qquad ( 9 )$$

$${\sum }_{j = 1}^{m} {I}_{j} = {W}_{irr} \qquad ( 10 )$$

Where j represents a jth week of the crop growth period; Iⱼ represents a single irrigation amount (in mm) at the jth week; T represents an irrigation start threshold (in mm); SWⱼ represents an initial moisture content (in mm) at the jth week; FC represents a soil field capacity (in mm); Iq represents an irrigating water quota (in mm) within the crop growth period; m represents a total irrigation frequency within a year; Wᵢᵣᵣ represents an irrigation norm (in mm); and Dⱼ represents a soil moisture deficit (in mm) at the jth week, which is expressed as follows:

$${D}_{j} = \qquad ( 11 )$$

$$\{ \begin{matrix}0 & \\ & if AWC - {PSs}_{j} - {PSu}_{j} \leq {P}_{j} + {I}_{j} \\ & if AWC - {PSs}_{j} - {PSu}_{j} > {P}_{j} + {I}_{j} \\ AWC - {PSs}_{j} - {PSu}_{j} - {P}_{j} - {I}_{j} & \end{matrix}$$

(3) Design a Method for Calculating Irrigation

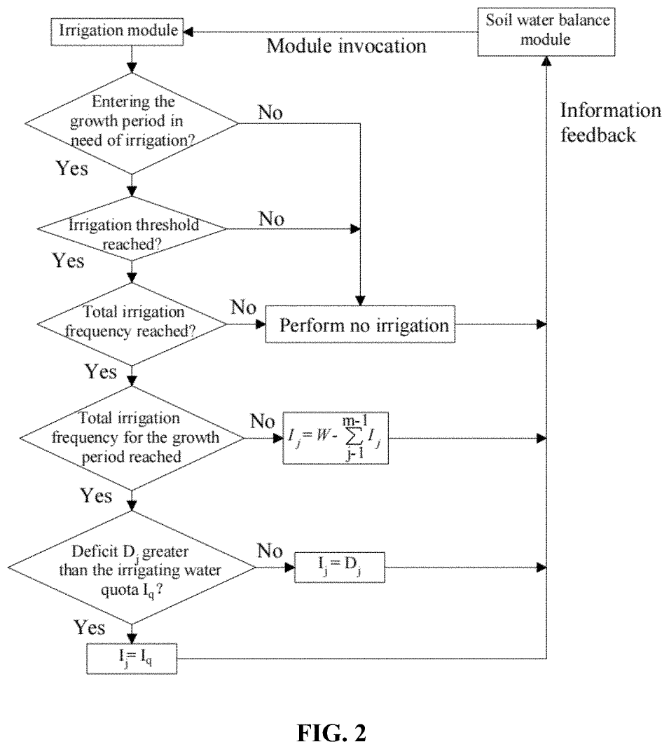

Design an irrigation calculation program in Visual Studio 2012, an application development environment for Windows platform in Fortran, allocate the irrigation water use per unit area to each crop growth period according to the irrigation start threshold, the soil moisture deficit, the irrigation time, the irrigating water quota for single irrigation and the irrigation frequency, and the running process is shown in FIG. 2:

1) Identification of an Irrigation Period

First, by invoking information on irrigation systems from the basic information database, identify whether a current calculation period is within an irrigation period: if not, perform no irrigation within this calculation period, return information to a soil water balance module; if yes, proceed into a process of identifying the irrigation start threshold;

2) Identification of an Irrigation Start Threshold

According to the calculation results of the water balance model, calculate a ratio of a soil moisture content to a field capacity: if the ratio is above the irrigation start threshold, perform no irrigation within this calculation period, and return information to the soil water balance module; and if the ratio is below the irrigation start threshold, proceed into a process of identifying the irrigation frequency within the growth period;

3) Identification of the Irrigation Frequency within the Growth Period

If the current irrigation frequency is higher than the total irrigation frequency within this growth period, perform no irrigation during this calculation period, and return information to the soil water balance module; and if the current irrigation frequency is not higher than the total irrigation frequency within this growth period, proceed into a process of identifying the total crop irrigation frequency;

4) Identification of the Total Crop Irrigation Frequency

If the current irrigation frequency is higher than the total crop irrigation frequency, perform no irrigation during this calculation period, and return information to the soil water balance module; if the current irrigation frequency is not higher than the total crop irrigation frequency, start irrigation, and then proceed into a process of identifying a soil moisture deficit, where the irrigation amount during this calculation period is equal to the irrigation water use per unit area minus a cumulative irrigation amount of previous irrigation;

5) Calculation of an Irrigation Amount

According to the calculation results of the water balance model, calculate a soil moisture deficit D: if the soil moisture deficit is higher than the irrigating water quota Iq, start irrigation, when the irrigation amount in this calculation period is equal to the crop irrigating water quota, return information to the soil water balance module; and if the soil moisture deficit is lower than the irrigating water quota, start irrigation, when the irrigation amount in this calculation period is equal to the soil moisture deficit, return information to the calculation process of soil water balance module. The irrigation calculation process is finished.

Step S4: construct a CMI-based drought evaluation model. Construct a CMI-based drought evaluation model by calculating, in combination with calculation of soil water balance, an evapotranspiration anomaly index based on the constructed basic information database and the improved soil water balance equation, and then calculating an excess moisture index according to a relevant CMI calculation formula.

The calculation process of each index in Step S4 is as follows:

(1) Calculation of the Evapotranspiration Anomaly Index

According to the principle of CMI, the evapotranspiration anomaly index is calculated according to the following formulas:

$$a = \overline{ET} / \overline{{ET}_{c}} \qquad ( 12 )$$

$$CET = a \cdot {ET}_{c} \qquad ( 13 )$$

$$DE = ( DE - CET ) / {a}^{1 / 2} \qquad ( 14 )$$

$${FY}_{j} = \frac{2}{3} \cdot {FY}_{j - 1} + 1.8 \cdot DE \qquad ( 15 )$$

$${Y}_{j} = \{ \begin{matrix}{FY}_{j} & if {FY}_{j} \leq 0 \\ \frac{PSs + PSu + Ss + Su}{2} \cdot AWC \cdot {FY}_{j} & if {FY}_{j} > 0\end{matrix} \qquad ( 16 )$$

Where α represents an evapotranspiration coefficient; E̅T̅ⱼ̅ and E̅T̅_̅{̅c̅j̅}̅ respectively represent a climatologically actual evapotranspiration and a climatologically potential evapotranspiration (in mm), which is obtained by calculating a long-time average annual value of climatologically actual evapotranspiration and potential evapotranspiration; CET represents an expected evapotranspiration (in mm); Y represents the evapotranspiration anomaly index; FY represents a first approximate value of Y; and DE represents an evapotranspiration anomaly value within a calculation stride (in week).

(2) Calculation of the Excess Moisture Index

According to the principle of CMI, the excess moisture index is calculated according to the following formula:

$$H = \{ \begin{matrix}{G}_{j - 1} & if {G}_{j - 1} < 12.7 \\ 25.4 & if 12.7 \leq {G}_{j - 1} < 25.4 \\ \frac{{G}_{j - 1}}{2} & if {G}_{j - 1} > 25.4\end{matrix} \qquad ( 17 )$$

$${G}_{j} = {G}_{j - 1} - H + \frac{PSs + PSu + Ss + Su}{2} \cdot AWC \cdot R + RO \qquad ( 18 )$$

Where G denotes the excess moisture index; and H denotes a regression factor.

(3) Calculation of CMI

According to the principle of CMI, the crop moisture index, as a sum of the evapotranspiration anomaly index and the excess moisture index, is expressed according to the following formula:

CMIⱼ=Yⱼ+Gⱼ (19)

Where CMI represents the crop moisture index.

The CMI-based drought evaluation model is constructed in combination with the formulas (1)-(19).

Step S5: evaluate agricultural drought. Estimate a CMI by adopting the constructed CMI-based drought evaluation model, and evaluate historical and current drought severity of a region in accordance with a CMI-based drought grading standard.

Step S5 specifically includes: design a program in Visual Studio 2012, an application development environment for Windows platform in Fortran so as to achieve information interaction between the soil water balance module and the irrigation module, after a calculation program for the CMI-based drought evaluation model covering formulas (1)-(19) is completed, calculate the CMI of each meteorological station in the research area, and evaluate historical and current drought severity of the research area in accordance with a CMI-based drought grading standard.

The beneficial effects of the present disclosure are illustrated below with reference to specific examples of model application:

1. Overview of a Research Area

In the embodiment of the present disclosure, Haihe Basin is taken as an example for description. The plain area of the Haihe Basin is seated in the northern part of the North China Plain, between 113° 27′ and 119° 50′ east longitude and 36° 05′ and 42° 40′ north latitude, with an average altitude of about 200 m. Bounded by the Taihang Mountains to the west, the Yanshan Mountains to the north, the Liao River Basin to the northeast, and the Yellow River to the south, the Haihe Basin faces the Bohai Sea on the east. From northeast to southwest, the Yanshan Mountains and the Taihang Mountains form a towering barrier that surrounds the Haihe Plain. The mountains and plains almost intersect directly, leading to a very short range of transitional areas for hills. From the perspective of topography, the Haihe Plain is inclined toward the Bohai Sea from southwest, west and north sides. According to the causes of formation, these plains can be roughly divided into Piedmont plain, central plain and coastal plain. The plains cover an area of 127,000 km², accounting for about 40% of the total area of the Haihe Basin. The Haihe Basin flows through 8 provinces (cities, autonomous regions), including Beijing, Tianjin, south central of Hebei Province, north of Shandong Province and Henan Province, being comprised of the Haihe River, Luanhe River, Tu Hai-Majia River and other water systems.

The plain area of the Haihe Basin is a densely populated region that boasts a developed economy, and a long history of agricultural reclamation. The area of cultivated land is more than 150 million mu, accounting for 10% of the cultivated land in China. It is the agricultural district with the largest planting area of wheat, corn and other food crops in the country. The double cropping adopted is the growing of winter wheat and summer corn. Under normal circumstances, wheat is sown in early October and harvested in early June of the following year. Maize is sown in mid-to-late June and harvested in late September of that year. During the whole growth and development period, wheat needs to be irrigated 4-5 times, and corn needs to be irrigated 2-3 times, which consumes a large volume of water. However, due to the influence of continental monsoon climate, the precipitation in this area is not abundant, the annual precipitation is only 400-900 mm, and the precipitation in the north is the least, with an average of 500-600 mm. Moreover, the precipitation varies greatly from year to year, and is unevenly distributed in time and space distribution. The precipitation in summer is relatively large, which accounts for ⅔ of the annual precipitation. Spring is in the critical period for the growth of winter wheat, however, the precipitation in spring is less than 100 mm, which is hardly enough to meet the needs for the water. Drought disasters occur frequently, particularly in spring. Therefore, agricultural irrigation has become an indispensable measure to ensure the normal growth and development of crops and to achieve the goal of stable grain production.

2: Construction of a Basic Information Database

The data required for model construction include information on a meteorological station, meteorological observation data, information on soil characteristics, information on crop characteristics, information on irrigation systems, data about irrigation water and statistical data about disasters that occurred in history.

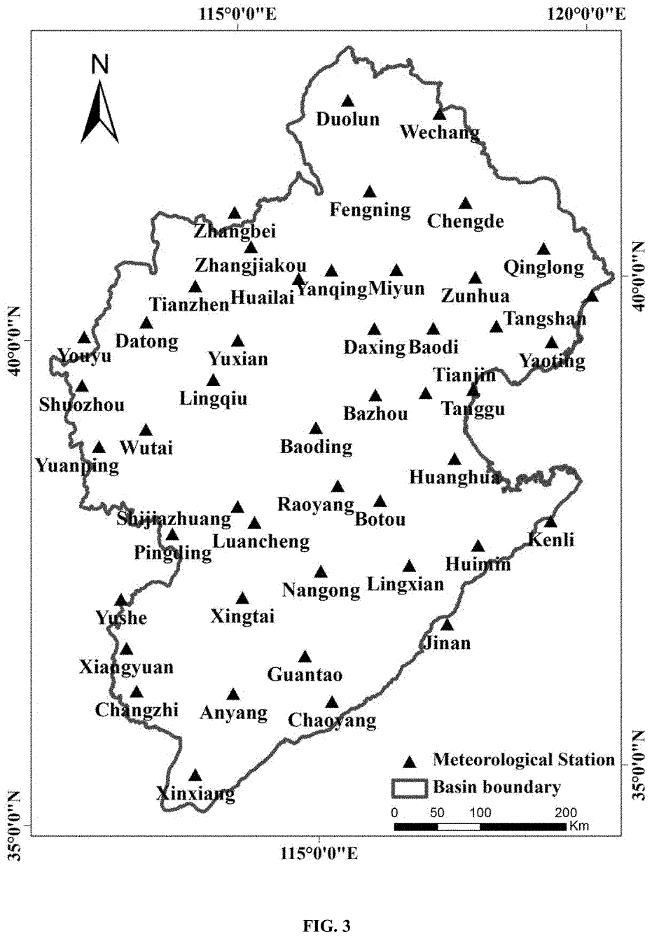

(1) Collect a diagram showing distribution of meteorological stations in Haihe Basin, as shown in FIG. 3.

(2) Collect a series of meteorological observation data from the China Meteorological Data Service Center (http://data.cma.cn/), including meteorological data from 1990 to 2012 in 48 meteorological stations in and around the Haihe Basin, including daily precipitation, daily maximum and minimum temperature, relative humidity, hours of sunshine, and wind speed.

(3) Obtain main parameters such as soil thickness and particle size composition by querying Soil Science Database (http://vdb3.soil.csdb.cn/). Calculate soil parameters such as field capacity rate and wilting coefficient by a Soil-Plant-Air-Water (SPAW) model.

(4) Collect parameter information of crops by consulting relevant literature, including the main crop types, planting system and crop coefficient for each growth period in the region where the meteorological station is located (Table 1).

(5) Collect information on irrigation systems, such as a crop irrigation norm, an irrigation time, an irrigation frequency, and a single irrigation amount (Table 2).

(6) Collect an actual irrigation water use over the years, an actual irrigation area and an effective utilization coefficient of irrigation water for a specified region.

TABLE 1

| | Crop | | | | | | | | |
|---|---|---|---|---|---|---|---|---|---|
| | Winter wheat | | | | | Summer corn | | | |
| | Sowing - | | Seedling | | Grain- | Sowing - | | | Grain- |
| Growth | seedling | Wintering | establishment - | | filling - | seedling | | | filling - |
| period | emergence | period | jointing | Heading | harvesting | emergence | Jointing | Heading | harvesting |
| Kc | 0.7 | 0.4 | 0.4-1.1 | 1.1 | 1.1-0.6 | 0.36 | 0.36-1.1 | 1.1 | 1.1-0.5 |

| | Crop | | | | |
|---|---|---|---|---|---|
| | Spring corn | | | | |
| | Sowing - | Seedling | | Tasseling - | Milky |
| Growth | seedling | emergence - | Jointing - | milky | maturity - |
| period | emergence | jointing | tasseling | maturity | harvesting |
| Kc | 0.5 | 0.85 | 1.05 | 0.95 | 0.6 |

TABLE 2

| | | | Irrigation | | |
|---|---|---|---|---|---|
| | | | | Water | Irrigation |
| | Crop | | | volume | start |
| Region | type | Irrigation period | Frequency | (mm) | threshold |
| Western Hebei | Winter | Sowing stage (from October 1 to October | 1 | 58 | 0.6 |
| | | 10) | | | |
| Province, Beijing, | wheat | Tillering stage (from November 20 to | 1 | 80 | 0.5 |
| Tianjin, and | | December 10) | | | |
| southern Shanxi | | Jointing stage (from March 10 to April 14) | 1 | 65 | 0.55 |
| Province | | Heading stage (from April 10 to April 30) | 1 | 68 | 0.55 |
| | | Milky maturity stage (from May 1 to May | 2 | 75 | 0.55 |
| | | 30) | | 67 | 0.55 |
| | Summer | Jointing stage (from July 1 to July 30) | 1 | 64 | 0.55 |
| | corn | Milky maturity stage (from August 20 to | 1 | 64 | 0.6 |
| | | September 20) | | | |
| Shandong Province, | Winter | Sowing stage (from October 15 to October 30) | 1 | 63 | 0.6 |
| northern Henan | wheat | Tillering stage (from November 20 to | 1 | 70 | 0.5 |
| Province, and | | December 10) | | | |
| eastern Hebei | | Jointing stage (from March 10 to April 14) | 1 | 65 | 0.55 |
| Province | | Heading stage (from April 10 to April 30) | 1 | 70 | 0.55 |
| | | Milky maturity stage (from May 1 to May | 2 | 67 | 0.55 |
| | | 30) | | 65 | 0.55 |
| | Summer | Jointing stage (from July 1 to July 20) | 1 | 61 | 0.55 |
| | corn | Milky maturity stage (from August 1 to | 1 | 71 | 0.6 |
| | | August 30) | | | |
| Shanxi Province | Spring | Jointing stage (from June 10 to July 10) | 1 | 75 | 0.55 |
| and northern | corn | Tillering stage (from July 20 to July 30) | 1 | 75 | 0.6 |
| Hebei Province | | Milky maturity stage (from August 1 to | 1 | 75 | 0.6 |
| | | August 30) | | | |

3. Calibration of the Soil Water Balance Equation

Use the daily meteorological data and irrigation data from 2007 to 2012 in Luancheng district of Hebei Province to simulate the changes of farmland soil humidity in order to verify the improved soil water balance equation.

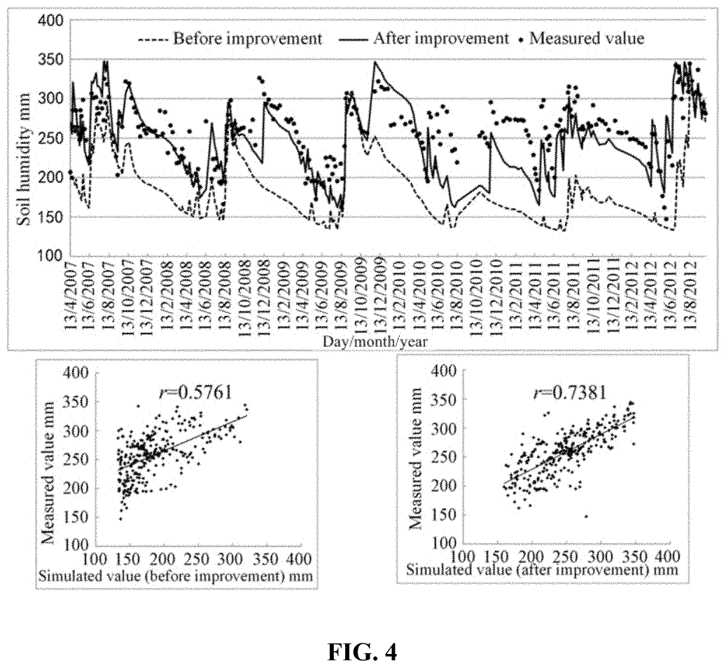

The calculated dry and wet conditions of farmland soil are compared with the measured results, and with the actual situation of agricultural drought. The results are shown in FIG. 4. The simulation results show that the improved soil water balance equation can more accurately reflect the actual changes of soil moisture, improve the sensitivity to short-term dynamic changes in dry and wet conditions of farmland soil, and make the agricultural drought evaluation more consistent with the actual situation.

4. Contrastive Analysis of the Drought Evaluation Effect

Based on the CMI model established above, firstly, completely simulate the dry-wet replacement process of Haihe Basin from 1990 to 2013. On this basis, select a representative drought process with historical records (2002) to calculate the whole process of the occurrence, development and end of agricultural drought in Haihe Basin during 2002, and compare the evaluation results based on two kinds of CMI before and after improvement. The output of the model is the drought grade distribution map indicated by CMI, and the time scale is week.

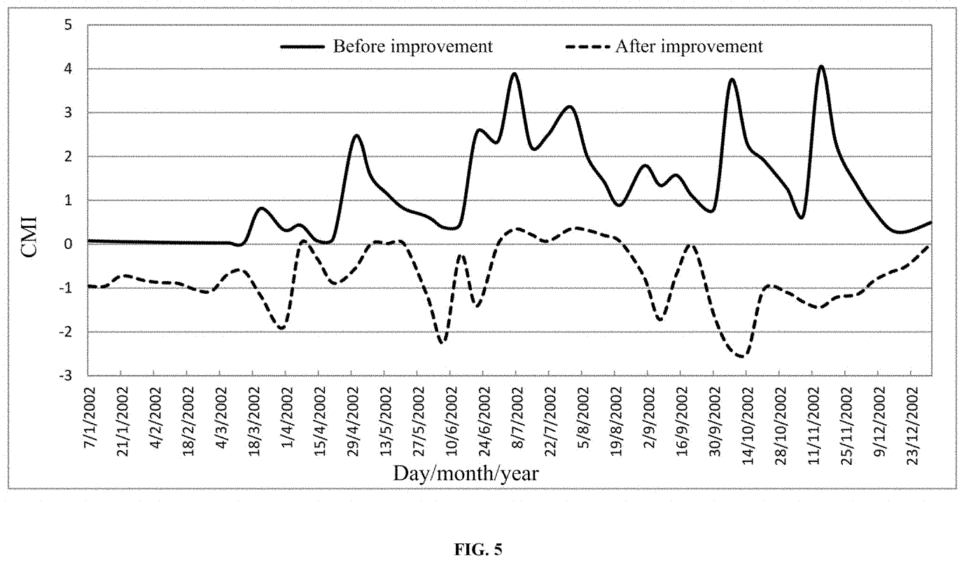

Refer to the table of drought grade based on CMI (Table 3), take Luancheng Station as the representative (FIG. 5), and verify the evaluation effects based on the two CMI indicators. According to historical records, a summer and autumn drought occurred in central Shandong in July 2002, which rapidly spread to northwest regions such as Henan, Beijing, Tianjin and southeastern and eastern Hebei from August to September, ending in December. Historical records show that in July and September 2002, due to timely rainfall in central Shanxi and western Hebei, the relative humidity of soil varied between 60% and 70%. In August, due to the small rainfall, western Hebei saw a decrease in soil moisture content. From July to September, the western part of Hebei Province went back to the grade of “normal” to “wet”. As can be seen from FIG. 5 (1), the evaluation results based on the improved CMI are relatively close to the historical records, and the CMI shows the transformation from normal to slight drought, showing the gradual process of the occurrence and deterioration of drought. In addition, historical records show that from October to December 2002, the relative humidity of soil in the central and western regions of Hebei Province varied from 60% to 70%, which belongs to the grade of “wet” or “slightly wet”. Luancheng Station performed irrigation twice in early October and December. The improved CMI showed the grade of “wet” or “slightly wet”, while CMI showed the grade of “slightly dry”. It can be seen that the improved CMI is more effective in the evaluation of agricultural drought.

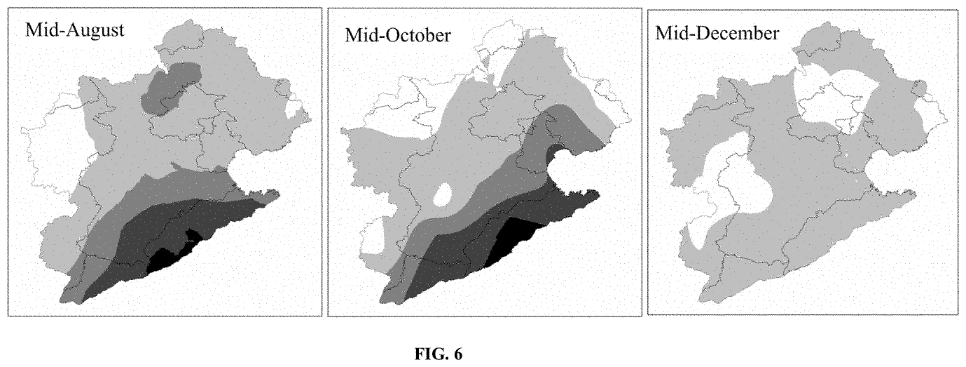

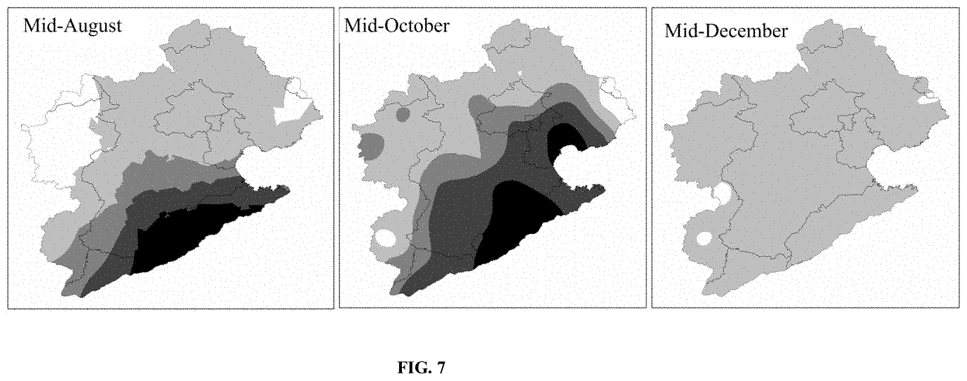

The comparison on spatial distribution of agricultural drought in Haihe Basin with two types of CMI in 2002 is shown in FIG. 6 to FIG. 7. According to the ten-day report on agricultural disasters, from July to August 2002, there was less precipitation and higher temperature in North China, and the drought worsened at a fast pace, spreading from southeast to northwest regions like Hebei and Henan. The improved CMI shows that dry climate occurs in southeastern Hebei Province and northern Shandong Province in August and persists from September to October. The CMI shows that the northeast of Hebei Province experiences dry or excessively dry climate in August, and there was a severely dry climate in Shandong and Hebei in October, which is not consistent with the actual situation. According to the measured data, from November to December, the soil moisture content in most areas of Hebei Province and Shandong Province varies from 60% to 70%, which belongs to the category of slight wetness or normal wetness. The improved CMI shows that the drought weakens obviously in December, which is close to the historical record. By contrast, the CMI shows that there is still drought in the whole Haihe basin in December, which is different from the actual situation.

Through the comparison of the two kinds of CMI, it can be seen that the result of agricultural drought evaluation from the improved CMI is more consistent with the actual situation recorded in the literature.

TABLE 3

| Drought grade | CMI |
|---|---|
| Severely wet | ≥3.00 |
| Excessively wet | 2.00-2.99 |
| Wet | 1.00-1.99 |
| Slightly wet | 0.99-0.0 |
| Slightly dry | 0.0-−0.99 |
| Dry | −1.0-−1.99 |
| Excessively dry | −2.0-−2.99 |
| Severely dry | ≤−3.00 |

The present disclosure provides a method for evaluating agricultural drought based on an improved CMI. In view of the poor accuracy of CMI when used in evaluating the drought of areas with frequent agricultural irrigation activities, based on the concept of drought in the Anthropocene and the construction principle of CMI, the water balance model in CMI is improved by the irrigation start threshold method combined with local irrigation system. In this way, an agricultural drought index considering the irrigation process is established to evaluate the drought in irrigated farming areas. According to the method, weather information and agricultural irrigation activities are integrated to dynamically evaluate drought development, the accuracy of agricultural drought evaluation and the timeliness of monitoring are improved, and the method has advantages in drought evaluation of a high-frequency irrigation farming area, so that a new method is provided for in-depth knowledge of an agricultural drought mechanism under the influence of strong human activities. The method is of great significance in guiding drought risk management and defense for large farming areas.

The above described are merely specific implementations of the present disclosure, and the protection scope of the present disclosure is not limited thereto. Any modification or replacement easily conceived by those skilled in the art within the technical scope of the present disclosure should fall within the protection scope of the present disclosure. Therefore, the protection scope of the present disclosure should be subject to the protection scope of the claims.

What is claimed is:

1. A method for evaluating agricultural drought based on an improved crop moisture index (CMI), comprising:
step S1: constructing a basic information database, wherein the basic information database comprises information on a meteorological station in a research area, meteorological observation data, information on soil characteristics in a region where the meteorological station is located, information on crop characteristics, information on irrigation systems, and irrigation-related information;
step S2: improving a soil water balance equation, which specifically comprises considering a crop coefficient during evapotranspiration calculation, and adding an irrigation parameter to a calculation formula for soil water loss and a calculation formula for evapotranspiration;
step S3: setting an irrigation start threshold, calculating weekly soil water deficit by using the improved soil water balance equation in step S2, and then allocating irrigation water use per unit area within a year according to the information on irrigation systems;
step S4: constructing a CMI-based drought evaluation model by calculating, in combination with calculation of soil water balance, an evapotranspiration anomaly index based on the constructed basic information database and the improved soil water balance equation, and then calculating an excess moisture index according to a relevant CMI calculation formula; and
step S5: estimating a CMI by adopting the constructed CMI-based drought evaluation model, and evaluating historical and current drought severity of a region in accordance with a CMI-based drought grading standard.

2. The method for evaluating agricultural drought based on an improved CMI according to claim 1, wherein said constructing a basic information database in step S1 comprises:
collecting information on a meteorological station in a research area, such as latitude and longitude coordinates and a sea level elevation of the meteorological station;
collecting a series of meteorological observation data, such as precipitation, hours of sunshine, radiation, wind speed, relative humidity, mean temperature, maximum temperature and minimum temperature;
collecting information on soil characteristics in a region where the meteorological station is located, such as a soil thickness, particle size composition, a field capacity rate and a wilting coefficient;
collecting information on crop characteristics, such as main crop types, planting dates, harvest dates, start and end dates of each growth period and a crop coefficient for each growth period in the region where the meteorological station is located;
collecting information on irrigation systems, such as a crop irrigation norm, an irrigation time, an irrigation frequency, and a single irrigation amount; and
collecting irrigation-related information, such as an actual irrigation water use over the years, an actual irrigation area and an effective utilization coefficient of irrigation water for a specified region.

3. The method for evaluating agricultural drought based on an improved CMI according to claim 2, wherein said considering a crop coefficient during evapotranspiration calculation in step S2 specifically comprises:
invoking the constructed basic information database to obtain a crop coefficient K_{c}, and calculating a potential evapotranspiration value ET_{c} of field crops in each growth period to replace potential evapotranspiration (PE) in an original CMI, wherein the potential evapotranspiration value of crops is calculated according to the Penman-Monteith equation provided by the Food and Agriculture Organization of the United Nations (FAO-PM equation) as follows:
ET_{c}=K_{c}·PE (1)
wherein ET_{c} represents a potential evapotranspiration value of crops (in mm) during a calculation period; PE represents potential evapotranspiration, namely reference crop evapotranspiration (in mm) during the calculation period; and K_{c} represents a crop coefficient within the corresponding time period; and
said adding an irrigation parameter to a calculation formula for soil water loss and a calculation formula for evapotranspiration in step S2 specifically comprises:
adding the irrigation parameter to the following formulas: the calculation formula for water loss of a surface soil layer (Ls), the calculation formula for water loss of an underlying soil layer (Lu) and the calculation formula for actual evapotranspiration (ET), wherein the revised calculation formulas are as follows:
L_{S}=min(ET_{c}−P−I,PSs) (2)
Lu=min[(ETc−P−I−Ls)·PSu/AWC,PSu] (3)
ET=Ls+Lu+P+I (4)
wherein P represents precipitation (in mm); I represents an irrigation amount (in mm); PSs and PSu represent an initial moisture content (in mm) of a surface soil layer and an initial moisture content (in mm) of an underlying soil layer, respectively; AWC represents an effective soil moisture content (in mm) which is obtained from a current soil moisture content minus a wilting moisture content; and R and RO represent a soil water supply (in mm) and runoff (in mm), respectively, R and RO being expressed as follows:
R=Su+Ss−PSs+PSu; if R>0,R+PSu+PSs≤AWC (5)
RO=PSu+PSs−Ss−Su−AWC; if RO>0 (6)
Ss=PSs−Ls (7)
Su=PSu−Lu (8)
wherein Ss and Su represent a moisture content of a surface soil layer and a moisture content of an underlying soil layer at the end of the period, respectively.

4. The method for evaluating agricultural drought based on an improved CMI according to claim 3, wherein step S3 specifically comprises:
invoking the constructed basic information database to obtain an actual irrigation water use over the years, an irrigation area and an effective utilization coefficient of irrigation water, and calculating irrigation water use per unit area;
setting the irrigation start threshold according to requirements of crop growth for soil moisture, wherein the irrigation start threshold is a ratio of a minimum soil moisture content to a field capacity required to ensure normal growth of crops, and is used to determine critical conditions for irrigation, irrigation is started only when the soil moisture content is below a threshold, and for a specified growth period, a single irrigation amount in a jth week is expressed as follows:
$${I}_{j} = \{ \begin{matrix}0 & if T \leq {SW}_{j} / FC \\ min ( {D}_{j} , Iq ) & if T > {SW}_{j} / FC\end{matrix} \qquad ( 9 )$$
$${\sum }_{j = 1}^{m} {I}_{j} = {W}_{irr} \qquad ( 10 )$$
wherein n represents a number of weeks of a specified growth period, and j represents a jth week of the crop growth period, and j=1, 2, . . . , n; Iⱼ represents a single irrigation amount (in mm) at the jth week; T represents an irrigation start threshold (in mm); SWⱼ represents an initial moisture content (in mm) at the jth week; FC represents a soil field capacity (in mm); I_{q} represents an irrigating water quota (in mm) within the crop growth period; m represents a total irrigation frequency within a year; Wᵢᵣᵣ represents an irrigation norm (in mm); and Dⱼ represents a soil moisture deficit (in mm) at the jth week, which is expressed as follows:
$${D}_{j} = \qquad ( 11 )$$
$$\{ \begin{matrix}0 & \\ & if AWC - {PSs}_{j} - {PSu}_{j} \leq {P}_{j} + {I}_{j} \\ & if AWC - {PSs}_{j} - {PSu}_{j} > {P}_{j} + {I}_{j} \\ AWC - {PSs}_{j} - {PSu}_{j} - {P}_{j} - {I}_{j} & \end{matrix}$$
allocating the irrigation water use per unit area to each crop growth period according to the irrigation start threshold, the soil moisture deficit, the irrigation time, the irrigating water quota for single irrigation and the irrigation frequency, which specifically comprises:
first, according to information on irrigation systems in the basic information database, identifying whether a current calculation period is within an irrigation period: if not, performing no irrigation within this calculation period, returning to a calculation process of soil water balance, and continuing to calculate a soil hydrological process (SHP); if yes, proceeding into a process of identifying the irrigation start threshold;
according to the calculation results of soil water balance, calculating a ratio of a soil moisture content to a field capacity: if the ratio is above the irrigation start threshold, performing no irrigation within this calculation period, returning to the calculation process of soil water balance, and continuing to calculate the SHP; if the ratio is below the irrigation start threshold, proceeding into a process of identifying the irrigation frequency within the growth period;
if the current irrigation frequency is higher than the total irrigation frequency within this growth period, performing no irrigation during this calculation period, returning to the calculation process of soil water balance, and continuing to calculate the SHP; if the current irrigation frequency is not higher than the total irrigation frequency within this growth period, proceeding into a process of identifying the total crop irrigation frequency;
if the current irrigation frequency is higher than the total crop irrigation frequency, performing no irrigation during this calculation period, returning to the calculation process of soil water balance, and continuing to calculate the SHP; if the current irrigation frequency is not higher than the total crop irrigation frequency, starting irrigation, and then proceeding into a process of calculating an irrigation amount, wherein the irrigation amount during this calculation period is equal to the irrigation water use per unit area minus a cumulative irrigation amount of previous irrigation; and
according to the calculation results of water balance, calculating a soil moisture deficit D: if the soil moisture deficit is higher than the irrigating water quota Iq, starting irrigation, when the irrigation amount in this calculation period is equal to the crop irrigating water quota, returning to the calculation process of soil water balance, and continuing to calculate the SHP; if the soil moisture deficit is lower than the irrigating water quota, starting irrigation, when the irrigation amount in this calculation period is equal to the soil moisture deficit, returning to the calculation process of soil water balance, and continuing to calculate the SHP.

5. The method for evaluating agricultural drought based on an improved CMI according to claim 4, wherein the evapotranspiration anomaly index in step S4 is calculated according to the following formula:
$$a = \overline{ET} / \overline{{ET}_{c}} \qquad ( 12 )$$
$$CET = a \cdot {ET}_{c} \qquad ( 13 )$$
$$DE = ( DE - CET ) / {a}^{1 / 2} \qquad ( 14 )$$
$${FY}_{j} = \frac{2}{3} \cdot {FY}_{j - 1} + 1.8 \cdot DE \qquad ( 15 )$$
$${Y}_{j} = \{ \begin{matrix}{FY}_{j} & if {FY}_{j} \leq 0 \\ \frac{PSs + PSu + Ss + Su}{2} \cdot AWC \cdot {FY}_{j} & if {FY}_{j} > 0\end{matrix} \qquad ( 16 )$$
wherein α represents an evapotranspiration coefficient; E̅T̅ and E̅T̅_̅{̅c̅}̅, respectively represent a climatologically actual evapotranspiration and a climatologically potential evapotranspiration (in mm), which is obtained by calculating a long-time average annual value; CET represents an expected evapotranspiration; Y represents the evapotranspiration anomaly index; FY represents a first approximate value of Y; and DE represents an evapotranspiration anomaly value within a calculation stride;
the excess moisture index is calculated according to the following formula:
$$H = \{ \begin{matrix}{G}_{j - 1} & if {G}_{j - 1} < 12.7 \\ 25.4 & if 12.7 \leq {G}_{j - 1} < 25.4 \\ \frac{{G}_{j - 1}}{2} & if {G}_{j - 1} > 25.4\end{matrix} \qquad ( 17 )$$
$${G}_{j} = {G}_{j - 1} - H + \frac{PSs + PSu + Ss + Su}{2} \cdot AWC \cdot R + RO \qquad ( 18 )$$
wherein G denotes the excess moisture index; and H denotes a regression factor;
the crop moisture index, as a sum of the evapotranspiration anomaly index and the excess moisture index, is expressed according to the following formula:
CMIⱼ=Yⱼ+Gⱼ (19)
wherein CMI represents the crop moisture index, and
the CMI-based drought evaluation model is constructed in combination with the formulas (1)-(19).

6. The method for evaluating agricultural drought based on an improved CMI according to claim 5, wherein step S5 specifically comprises: according to the formulas (1)-(19), compiling a calculation program of the CMI-based drought evaluation model in Visual Studio, an application development environment for Windows platform, calculating the CMI of each meteorological station in the research area, and evaluating historical and current drought severity of the research area in accordance with a CMI-based drought grading standard.
